(19) United States
(12) Patent Application Publication
(10) Pub. No.: US 2009/0210900 A1
(43) Pub. Date: Aug. 20, 2009

(54) OUT-OF-BAND DELIVERY OF TARGETED ADVERTISING

(76) Inventor: Ilan Kaftan, Los Altos, CA (US)

Correspondence Address: WALL & TONG, LLP/;ALCATEL-LUCENT USA INC., 595 SHREWSBURY AVENUE, SHREWSBURY, NJ, 07702, US

(21) Appl. No.: 12/199,944

(22) Filed: Aug. 28, 2008

Related U.S. Application Data
(60) Provisional application No. 61/030,138, filed on Feb. 20, 2008.

(51) Int. Cl. H04N 7/025; H04N 7/12; H04N 7/173

(52) U.S. Cl. 725/34; 725/35; 725/111; 725/131

(57) ABSTRACT

A method and system to deliver targeted advertisements to a set-top box including a cable modem by causing the selection for presentation of a targeted advertisement received via the cable modem instead of a default advertisement received via an in-band digital television delivery channel.

### FIELD OF THE INVENTION

The invention relates to communications networks and, more particularly, to the delivery of targeted advertising within a digital television network transporting both video and data streams.

### BACKGROUND

Stream conditioning for the switching of addressable content in digital television receivers is known. For example, the Society Of Cable Telecommunications Engineers (Digital Video Subcommittee) DVS-766 standard (Stream Conditioning for Switching of Addressable Content in Digital Television Receivers) contemplates alternate content delivery in digital television systems.

Briefly, a primary channel multiplex stream includes audio and video streams associated with network-provided content including default advertising. The primary channel multiplex stream is conditioned to include signaled switch points delineating the boundary between the network provided content and the default advertising. The signaled switch points are temporally preceded by metadata triggers which are used by subsequent processing elements such as a set-top box (STB) to identify the impending start of default advertising. In this manner, the STB may timely select for presentation alternate advertising in place of the default advertising. The alternate advertising is one of a plurality of advertising streams included within an advertisement channel multiplex stream. Primary channel multiplex streams and advertisement multiplex streams are transported in-band to the digital television network subscribers. An example of stream conditioning according to the DVS-766 standard is discussed in more detail below with respect to FIG. 4.

### BRIEF SUMMARY

Various deficiencies of the prior art are addressed by the present invention of using high-speed Internet (HSI)/high-speed data (HSD) bandwidth to push targeted ads to a set-top box (STB). Specifically, a set-top box including a cable modem is adapted to select a targeted advertisement received via the cable modem instead of a default advertisement received via the in-band digital television delivery channel. A networking device such as a router upstream from the STB provides targeted advertisements to the cable modem termination system (CMTS) associated with the STB. A splicer in the networking device may be used to direct specific targeted advertisements to the STB.

In an alternate embodiment, an information delivery system including separate data paths and video paths (such as FiOS) propagates toward client devices content and default advertising via a video path and alternate advertising via a data path. The client selects the alternate (data path) or default (video path) advertising in response to the presence or absence of a splice point indicator.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a simplified digital television distribution system according to one embodiment;

FIG. 2 depicts a high-level block diagram of a simplified set top box (STB) suitable for use in a distribution system of FIG. 1;

FIG. 3 graphically depicts a switching operation according to an embodiment;

FIG. 4 depicts a graphical representation of a primary channel multiplex stream and an advertisement channel multiplex stream conditions substantially in accordance with the DVS-766 standard; and

FIG. 5 depicts a flow diagram of a method according to one embodiment.

To facilitate understanding, identical reference numerals have been used, where possible, to designate identical elements that are common to the figures.

### DETAILED DESCRIPTION OF THE INVENTION

The invention will be primarily described within the context of a digital television distribution system adhering to particular standards. However, those skilled in the art and informed by the teachings herein will realize that the invention is generally applicable to any system utilizing the functions contemplated herein irrespective of the particular standard used. For example, the information is broadly applicable to any information delivery system or systems in communication with client devices via separate data paths/pipes and video paths/pipes, such as the fiber-optic service (FiOS) provided by Verizon Communications, Inc. In such systems, content and default advertising is propagated towards client devices via the video path, while alternate advertising is propagated toward client devices via the data path. The client device selects the alternate (data path) or default (video path) advertising in response to the presence or absence of a splice point indicator (or via some other control mechanism).

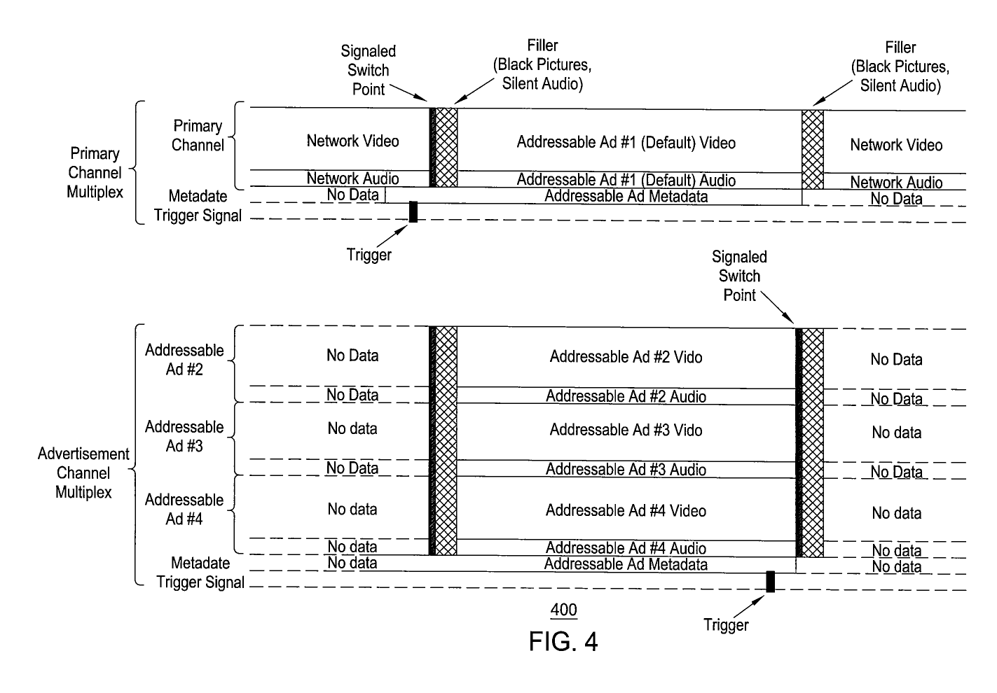

FIG. 4 depicts a graphical representation of a primary channel multiplex stream and an advertisement channel multiplex stream in accordance with the DVS-766 standard. The primary channel multiplex stream includes a primary video stream, primary audio stream and metadata/in trigger signal. The primary video and audio streams may carry either network programming or advertisements. A signaled switch point (e.g., SCTE-35) indicates the termination of a network programming portion of the primary channel multiplex stream. The signaled switch point is followed by a filler portion comprising, illustratively, primary video representing black pictures and primary audio representing silence. The filler portion is followed by an advertising portion comprising respective video and audio streams as well as any metadata associated with the advertisement. The advertising portion is followed by another filler portion, which is then followed by network programming. A metadata trigger signal includes a trigger indication temporally preceding the signaled switch point.

The primary advertisement channel multiplex stream includes a plurality of filler portions and advertisements (respective video and audio streams) temporally aligned with the respective filler portions and advertisement of the primary channel multiplex stream. A signaled switch point within the filler portion following the advertisements indicates the termination of the advertisements. A metadata trigger signal includes a trigger indication temporally preceding the signaled switch point.

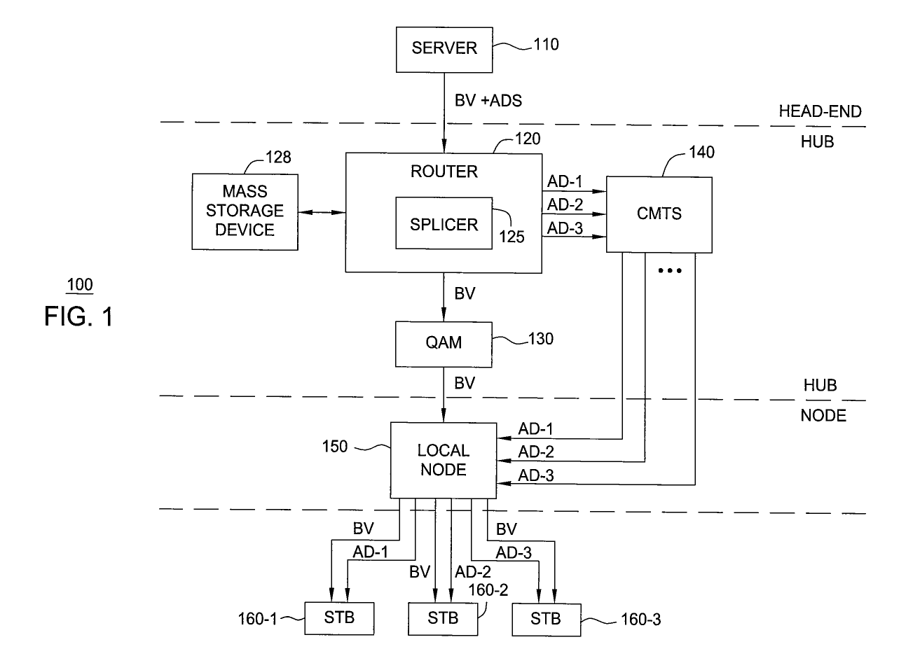

FIG. 1 depicts a high-level block diagram of a simplified digital television distribution system according to one embodiment. Specifically, the digital television distribution system 100 of FIG.1 includes a head end comprising a server 110 and other equipment (not shown). The head end 110 provides a plurality of primary channel multiplex streams such as broadcast video (BV) streams. Optionally, the server 110 provides advertisement channel streams (ADVERTS).

The streams provided by the head end 110 are conditioned to include indications of appropriate splicing/switching points. For the BV streams, splicing/switching points identify the stream points where network video is replaced by default advertising. For the AD streams, splicing/switching points identify the stream points where the advertisement ends. Optionally, a metadata trigger signal is associated with each of the streams such that equipment processing such streams receives timely indication of an impending splicing/switching point. In one embodiment, the streams are conditioned in the manner described herein with respect to FIG. 4. In related embodiments, multiple advertising streams are not multiplexed together.

A networking device (e.g., a router or switch with splicing capability) 120 receives the BV and, optionally, ADVERT streams provided by the head end 110. In one embodiment, the AD streams are stored in the networking device and/or a server associated with the networking device. The networking device 120 forwards the BV streams to, illustratively, a modulator 130 such as a quadrature amplitude modulator (QAM), CMT QAM, Edge QAM and the like, which modulates the BV streams according to a modulation format adapted for propagation via a hybrid fiber coaxial (HFC) network. The modulated BV streams are received by a local or neighborhood node 150 and propagated therethrough to each of a plurality of set top boxes (STBs) 160. It will be appreciated that while the embodiment of FIG. 1 is depicted as using quadrature amplitude modulation for in-band channel modulation, various other embodiments may use different in-band modulation schemes.

The networking device 120 is optionally associated with a mass storage device 128 or local storage 126 for storing advertisement streams. Thus, in various embodiments, advertisement streams are received from either the server 110 or mass storage device 128. Other sources (not shown) of advertising streams may also be used. In one embodiment, the head end 110 provides advertisement channel multiplex streams such as described herein with respect to FIG. 4. In another embodiment, the head end 110 provides non-multiplexed advertising streams. In either embodiment, the advertising streams may be stored in mass storage device 128 (or local storage 126 of the networking device 120) for subsequent distribution to set top box cable modems as unicast advertising streams.

The networking device 120 forwards targeted unicast advertising streams AD to a cable modem termination system (CMTS) 140, which in turn communicates the targeted advertising streams AD to their respective network destination addresses via the local/neighborhood node 150. Optionally, the CMTS is connected to an external modulator (QAM and the like) to provide any of aggregated broadband, digital video and/or video on demand. The network destination addresses are associated with respective cable modems within the set-top boxes 160.

The networking device 120 includes a splicer 125, which is used to select a particular advertisement stream to be forwarded to an STB. Specifically, the splicer 125 operates to select a particular advertising stream from either the server 110, mass storage device 128 or local storage 126 and process the selected advertising stream by, for example, associating internet protocol (IP) address information of the particular STB with the selected advertising stream. Information is optionally received from an Ads Decision System (ADS), such as defined in the SCTE-130 standard. The processed and selected advertising stream is then routed by the CMTS to the STB as a unicast stream.

Thus, each STB receives broadcast video multiplex streams via an in-band channel (a television delivery channel) of a standard digital television network, and unicast advertising streams via an out-of-band channel (a high-speed Internet delivery channel) of the standard digital television network. Each STB includes in-band processing circuitry for receiving and processing broadcast video streams. Each STB includes a cable modem for processing high-speed internet/data, including advertising streams addressed to the STB.

In operation, an STB processes the broadcast video stream being received via standard in-band processing circuitry (i.e., digital video input processing circuitry). Upon encountering a trigger or signaled switch point in the broadcast video stream, the STB begins processing an advertising stream (if one exists) being received via the cable modem. Upon encountering a trigger or signaled switch point in the advertising stream, the STB returns to processing the broadcast video stream.

In the embodiment of FIG. 1, a first advertising stream AD-1 is addressed to a first STB 160-1, a second advertising stream AD-2 is addressed to a second STB 160-2, and a third advertising stream AD-3 is addressed to a third STB 160-3. It will be appreciated that more or fewer advertising streams and/or STBs may be used, that any advertising stream may be directed to any STB, that multiple STBs may receive the same advertising streams and so on.

In one embodiment, a system and method for digital ad insertion includes a unit to mark a video bitstream with Internet protocol (IP) splice points based on cue tone signals embedded within the video bitstream (e.g., SCTE-35 messages). This unit may be located within the head end server 110. Alternatively, content and programming to be served by the head end may be received from the content source preprocessed to include the splice points.

The head end server 110 provides a single transport stream (TS) that is sent across a packet-based network to the networking device 120. Optionally, encapsulation in RTP packets is used. The splicer 125 within the networking device 120 is operable to receive the TS and detect the IP splice points disposed therein. In response to the detecting of IP splice point (e.g., the detection of an SCTE-35 message), the splicer 125 signals an advertising source to retrieve one or more advertisements for later processing proximate one of the IP splice points. Optionally, the splice point is marked in the RTP packet header (e.g., RFC 22500), which is detected to indicate the splice point. The advertising source may be the mass storage device 128 or a local storage device (not shown). Unicast advertisements are then propagated to the appropriate STBs for subsequent processing by their respective cable modems and advertisement insertion elements.

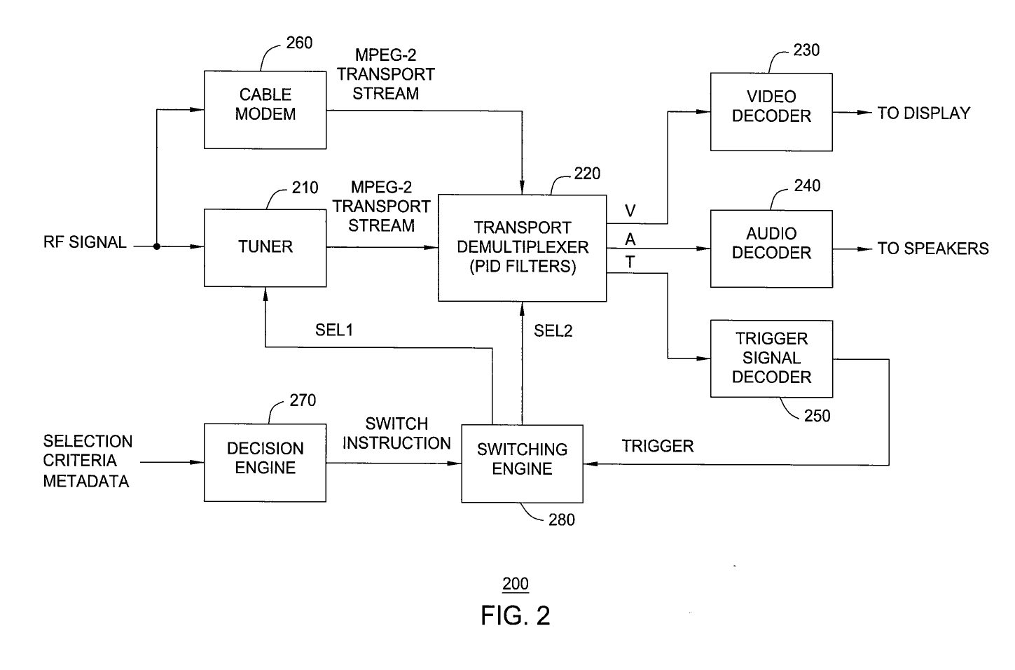

FIG. 2 depicts a high-level block diagram of a simplified set top box (STB) suitable for use in a distribution system of FIG. 1. Specifically, the STB 200 of FIG. 2 includes a tuner 210 for tuning and demodulating one of a plurality of available MPEG-2 transport stream propagated within an in-band portion of a received radio frequency (RF) signal such as the QAM signal discussed above. The tuner 210 is responsive to a first control signal SEL1 to select a particular MPEG-2 transport stream for further processing by a transport demultiplexer 220.

A cable modem 260 receives a unicast advertising stream via an out-of-band portion of the RF signal and provides the received advertising stream to the transport demultiplexer 220 for further processing. In the case of a unicast advertising stream there is no significant demultiplexing to be performed; rather, the transport demultiplexer 220 simply routes the video, audio and metadata portions of the unicast advertising stream to the appropriate subsequent processing circuitry.

A transport demultiplexer 220 utilizes packet identification (PID) information to extract a video stream V, audio stream A, and metadata trigger signal T from the MPEG-2 transport stream selected by the tuner 210. The transport demultiplexer 220 is responsive to a second control signal SEL2. The video stream is processed by a video decoder 230 to produce a video signal suitable for use by a video presentation device (i.e., a display). The audio stream is processed by an audio decoder 240 to produce audio signals suitable for use by an audio presentation device (i.e., speakers). The metadata trigger signal is processed by a trigger signal decoder 250 to identify thereby trigger points indicative of an impending occurrence of a signal switching point. Indication of identified trigger points is provided to a switching engine 280.

The switching engine 280 generates the first SEL1 and second SEL2 control signals in response to a switch instruction signal received from the decision engine 270 and the trigger indicative signal received from the trigger signal decoder 250.

In a first mode of operation, the switching engine 280 causes the tuner 210 and transport demultiplexer 220 to receive and process for presentation a primary channel multiplex transport stream. In a second mode of operation, the switching engine 280 causes the transport demultiplexer 220 to receive and process for presentation a unicast advertising stream received via the cable modem 260. Transitions between the two modes of operation are initiated by the trigger indicative signal received from the trigger signal decoder 250. Transitions between the two modes of operation are enabled by the switch instruction signal provided by a decision engine 270. Thus, if the switch instruction signal provided by the decision engine 270 is not in the “enable” state, the detection of or occurrence of trigger conditions will have no effect in the default advertisement within the broadcast video stream will be processed.

The decision engine 270 processes selection criteria metadata to determine thereby whether the STB should process the advertisements included within the primary channel multiplex stream (first mode of operation) or the advertisements received via the cable modem 260 (second mode of operation). The selection criteria metadata is included within the MPEG-2 transport stream received by the cable modem 260. The social criteria may also be preprogrammed or provided by other means.

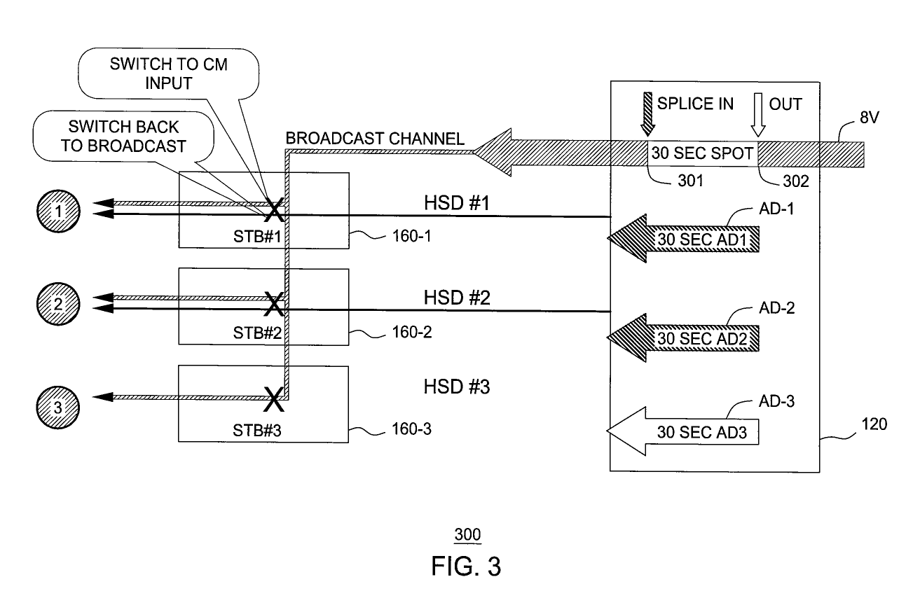

FIG. 3 graphically depicts a switching operation according to an embodiment. Specifically, the broadcast video BV propagates through the networking device 120 toward each of the STBs 160 via the in-band broadcast channel. It is noted that the network primary channel multiplex includes, illustratively, a 30 second advertisement (other time periods such as 15, 20, 45 seconds and so on may also be used) having associated with a starting point 301 (splice in) and ending point 302 (splice out). A metadata trigger signal associated with the primary channel multiplex includes trigger indicative information associated with the splice in 301 a splice out 302 points. In addition, three advertising streams AD-1, AD-2 and AD-3 propagate through the networking device 120 towards the set-top boxes via respective high-speed data (HSD) channels.

Each STB receives and processes for presentation the in-band received network primary channel multiplex programming until the splice-in indicative trigger is identified, at which time each STB selects for processing the advertising streams received via the out-of-band HSD channels. Each STB receives and processes for presentation the out-of-band received advertising streams until the splice-out indicative trigger is identified, by which time each STB selects for processing the in-band received network primary channel multiplex programming.

The above-described embodiments of the invention use HSI/HSD bandwidth to push the targeted ads to the STBs, while switching the input video within the STB from broadcast video input to cable modem input video. The splicer 125 is located upstream of the CMTS 140 such that, in one embodiment, the splicer 125 operates to manage the priorities of the HSI and video entering the CMTS. The splicer may be included within, or outside of, the networking device 120.

Various embodiments of the present invention use SCTE-35 signaling (Digital Program Insertion Cueing Message for Cable) to identify which advertisement streams are to be targeted to a specific set top box. Thus, in one embodiment, the networking device 120 receives SCTE-35 signaling from the server 110 or other source of streaming media such as an encoder or other streaming device. Upon identifying the SCTE-35 signal, the networking device 120 sends targeted advertisements to the specific STB via the DOCSIS (CMTS) while giving higher priority to the video over the HSI. In one embodiment such signaling is achieved by inserting meta data as define by DVS-766 into the primary channel and indicating the client within the STB to switch to the CM input.

In one embodiment, a system and method for digital ad insertion includes a unit to mark a video bitstream with Internet protocol (IP) splice points based on cue tone signals embedded within the video bitstream. The unit outputs a single transport stream (TS) that is sent across a packet-based network. A splicing device with an associated ad server is operable to receive the TS and detect the IP splice points. The splicing device signaling the ad server to retrieve one or more ads for insertion into the TS at one of the IP splice points.

It is noted that various embodiments may be implemented using any of a variety of network elements, such as routers, stand alone splicers, integrated splicers, client devices and the like. Generally speaking, various embodiments may be implemented by any networked device capable of intercepting an SCT-35 signal and responsively sending an advertisement to a client device via a data link (e.g., through a CMTS, FiOS data pipe or other data pipe).

In normal operation, program and default advertising is sent to and processed by a client device to produce, illustratively, a standard network programming display. In response to the interception of a SCT-35 tone signal intercepted by a network element, the network element causes and advertising stream to be transmitted to one or more specific client devices or set top boxes via a data link or data channel. The SCT-35 tone signal is indicative of the moment in time or portion of program stream associated with a splice operation where a different advertisement may be inserted or spliced in place of a default advertisement. The different advertisements may be stored in a splicer, router, client device, a remote server, local server common age server or any other storage device that may be caused to stream the advertisement to the client device.

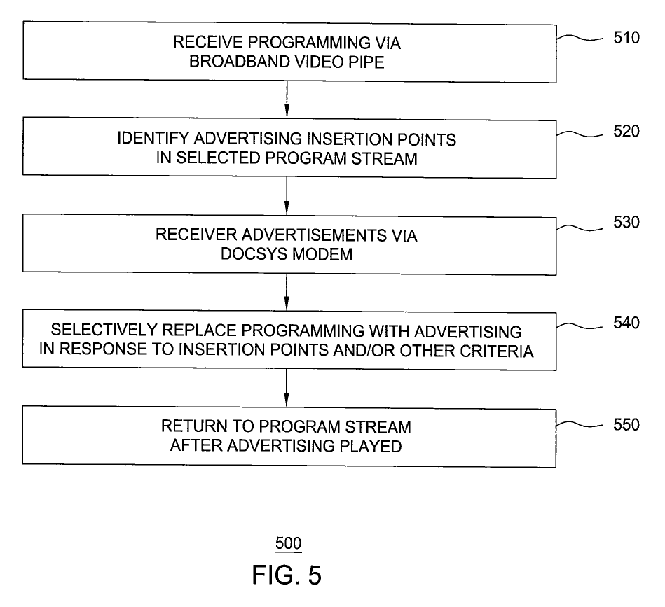

FIG. 5 depicts a flow diagram of a method according to one embodiment. Specifically, the method 500 of FIG. 5 is performed at a client to device such as a set top box (STB).

At step 510, the STB is receiving programming via a broadband video pipe such as a cable television forward application transport channel (FATC) or the video portion of a FiOS delivery system. The received programming is coupled to decoding circuitry and the like for subsequent processing to produce presentation signals for a display device.

At step 520, advertising insertion points within the programming received via the broadband video pipe are identified. Specifically, advertising insertion points within a program stream selected for presentation are identified.

At step 530, advertisements are received via a data pipe, such as via a cable modem or optical receiver adapted to a FiOS system. It is noted that the advertisements received a via data pipe have previously been propagated toward the STB via an upstream network element such as a splicer, router and the like. As previously noted, such a network element operates to intercept a programming transport stream to identify therein default advertising related splice points and responsively transmit toward the STB appropriate replacement advertising streams.

At step 540, in accordance with the identified advertising insertion points, the default advertising within the received programming stream is selectively replaced with alternate advertising. That is, the audiovisual stream (e.g., MPEG-2 transport stream) transporting the programming received a via the broadband video pipe is replaced as an input to the decoding circuitry by the audiovisual stream (e.g. MPEG-2 transport stream) transporting of the advertisements received a via the data pipe. This is implemented, illustratively, by splicing/switching circuitry within the STB that selectively applies one of the received video pipe transport stream and receive audio pipe transport stream to the decoder or other subsequent processing circuitry.

At step 550, the alternate advertising is replaced by the initial programming stream. That is, the audiovisual stream (e.g., MPEG-2 transport stream) transporting the programming received a via the data pipe is replaced as an input to the decoding circuitry by the audiovisual stream (e.g. MPEG-2 transport stream) transporting of the advertisements received a via the broadband video pipe.

Various network and other functional elements described above may be implemented in general purpose or special purpose computers. Such computer implementations include or cooperate with one or more processors, various support circuitry, input-output (I/O) circuitry, memory, communication buses and so on for receiving, processing, providing and/or exchanging information. The at least one processor may be any conventional processor for executing programs stored in memory. The memory may be any conventional volatile memory (e.g., RAM, DRAM, among others), non-volatile memory (e.g., disk drives, floppy, drives, CDROM, EPROMS, among other computer readable medium) or any other conventional memory device for storing data and various control programs, such as methodology according to the present invention. The processor cooperates with conventional support circuitry, such as power supplies, clock circuits, cache memory and the like, as well as circuits that assist in executing the various programs and routines, as well as other programs and data. As such, it is contemplated that some of the process steps discussed herein as software processes may be implemented within hardware, for example, as circuitry that cooperates with the processor to perform various steps. The input/output (I/O) circuitry forms an interface between the various functional elements communicating with each implemented network element or function.

Although the various elements described herein are depicted as a general-purpose computer that is programmed to perform various control functions in accordance with the present embodiments, various embodiments may be implemented in hardware such as, for example, an application specific integrated circuit (ASIC) or a field-programmable gate array (FPGA). As such, it is intended that the processes described herein be broadly interpreted as being equivalently performed by software, hardware, or a combination thereof.

The invention may be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

In one embodiment of the invention, a method for replacing broadcast advertising at a set top box (STB), comprises: receiving a plurality of broadcast television streams via a television signal transport network, each television stream including respective content portions and advertising portions delineated thereby using splice point indicators; receiving at least one advertising stream via a data transport network; in a first mode of operation, providing content portions and advertising portions of a desired broadcast television stream to presentation processing circuitry; and in a second mode of operation, using splice point indicators to selectively provide an advertising stream received from the data transport network to the presentation processing circuitry.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method, comprising:
receiving a plurality of program streams via a video transport network, each program stream including respective content portions and default advertising portions;
receiving at least one advertising stream via a data transport network;
providing the content and default advertising portions of a desired program stream to presentation processing circuitry; and
in response to a control signal associated with a default advertising portion of the desired program stream, providing to the presentation processing circuitry an advertising stream received via the data transport network.

2. The method of claim 1, wherein the control signal comprises an SCTE-35 signal.

3. The method of claim 1, wherein the video transport network comprises a quadrature amplitude modulated (QAM) transport network.

4. The method of claim 1, wherein the at least one advertising stream is provided to the data transport network via a cable modem termination system (CMTS).

5. The method of claim 1, wherein the video transport network and data transport network are included within a FiOS network.

6. The method of claim 1, wherein the program and advertising streams comprise MPEG-2 transport streams.

7. The method of claim 1, further comprising:
in response to a control signal associated with the advertising stream received via the data transport network, providing the desired program stream to the presentation processing circuitry.

8. The method of claim 1, wherein the advertising stream is received via a DOCSYS modem.

9. Apparatus, comprising:
a network element, for providing a plurality of program streams to a video transport network associated with a set top box, and for providing at least one advertising stream to a data network associated with the set top box, each program stream including respective content portions and default advertising portions; wherein
the program streams include a control signal indicative of a splice point between adjacent content and advertising portions, the control signal adapted to enable selection at the set top box of one of a video transport network provided program stream and a data network provided advertising stream during a presentation period normally associated with the default advertising portion of the program stream.

10. The apparatus of claim 9, further comprising:
a splicer, for selectively providing to the video transport network an alternate advertising stream instead of a default advertising portion of a program stream.

11. The apparatus of claim 9, further comprising:
a storage device, for storing alternate advertising streams.

12. The apparatus of claim 11, wherein the storage device comprises a remote storage device.

13. The apparatus of claim 9, wherein the network element is located at a hub within a television distribution system.

14. Apparatus, comprising:
a network element, for receiving a plurality of program streams via a video transport network and at least one advertising stream via a data network, each program stream including respective content portions and default advertising portions;
the network element operating in a first mode of operation to deliver a program stream to a set top box via a video transport network and in a second mode of operation to deliver an advertising stream to the set top box via a data network.

15. The network element of claim 13, wherein the network element is located at a node within a television distribution system associated with the set top box.

16. Apparatus, comprising:
a tuner, for selectively coupling to a demultiplexer one of a plurality of program streams received via a video transport network, each program stream including respective content portions and default advertising portions;
a modem, for coupling to the demultiplexer at least one advertising stream via a data transport network;
the demultiplexer selectively demultiplexing and providing to presentation circuitry one of the tuner provided program stream and the modem provided advertising stream in response to a control signal associated with a default advertising portion of the tuner provided program stream.

17. The apparatus of claim 16, further comprising:
a networking element, for providing a broadcast video stream adapted for delivery via the video transport network.

18. The apparatus of claim 17, wherein the networking element provides at least one advertising stream adapted for delivery via the data transport network.

19. The apparatus of claim 18, further comprising:
a cable modem termination system (CMTS), for transmitting the at least one advertising stream via the data transport network.
